(19) United States
(12) Patent Application Publication
(10) Pub. No.: US 2025/0304018 A1
(43) Pub. Date: Oct. 2, 2025

(54) ENERGY RECOVERY SYSTEM AND METHOD FOR VEHICLES

(71) Applicant: Mehron Berookim, Los Angeles, CA (US)

(72) Inventor: Mehron Berookim, Los Angeles, CA (US)

(21) Appl. No.: 18/625,134

(22) Filed: Apr. 2, 2024

(51) Int. Cl. B60T 1/10

(52) U.S. Cl. CPC B60T 1/10

(57) ABSTRACT

An energy recovery system for vehicles is disclosed herein. The energy recovery system utilizes a spring system connected to either a shock absorber or a braking mechanism or both. Through a linkage mechanism, kinetic energy generated from the movement of the shock absorber, or the application of the braking mechanism is transformed to wind up the spring system, storing potential energy. A control mechanism then allows for the release of this stored energy to aid in propelling the vehicle, enhancing overall energy efficiency.

### FIELD OF THE INVENTION

The present invention pertains to the field of automotive technology, and more particularly, to energy recovery systems in vehicles. The invention relates specifically to a system and method for capturing regenerative forces from shock absorbers and braking systems of a vehicle.

### BACKGROUND

Traditional automotive vehicles are designed to operate using energy from a fuel source, such as gasoline or diesel. Similarly, electric vehicles employ rechargeable batteries for their operation. However, a considerable amount of kinetic energy produced in these vehicles is wasted during operations such as braking, running over rough terrain, or during the absorption of shocks and vibrations. This lost energy contributes to inefficiency in the overall energy consumption of the vehicle, resulting in decreased fuel or battery efficiency.

Regenerative braking systems have been developed to recapture some of the lost energy during the braking process, converting kinetic energy into electric energy and storing it in a battery for later use. However, the energy conversion and storage processes in these systems have their own efficiency limitations. Moreover, these systems require complex electrical components and are thus vulnerable to electrical failures.

In addition, most regenerative systems do not capitalize on energy dissipated during shock absorption. Vehicles, particularly those used off-road such as 4×4 trucks, undergo substantial shock and vibrations which result in a significant amount of energy dissipation. Moreover, the systems that use any type of energy recapture, are electronic vehicles, rather than non-electric vehicles, which employ regenerative energy capable batteries.

Furthermore, these regenerative braking systems primarily focus on slowing the vehicle down and do not contribute to the vehicle's propulsion, thus limiting their utility.

Therefore, a persisting problem in the current state of technology is the lack of a comprehensive, mechanically robust, and efficient system to recover, store, and reuse the energy wasted in vehicular operations such as braking and shock absorption, which simultaneously enhances the vehicle's fuel or battery efficiency, improves propulsion, and provides a smoother ride.

### SUMMARY OF THE INVENTION

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

In one aspect of the invention, a system is provided. The system may be, for example, an energy recovery system for a vehicle. The vehicle may be any type of land vehicle, or water vehicle. In exemplary embodiments, the system may include: a spring system associated with at least one of a shock absorber and a braking mechanism of the vehicle; a linkage mechanism between said spring system and said at least one of shock absorber and braking mechanism, wherein energy from a movement of said shock absorber or an application of said braking mechanism winds up said spring system, thereby storing potential energy; and a control mechanism that releases the stored potential energy in said spring system to provide propulsion to the vehicle.

In another aspect of the invention, a method is provided. The method may be a method of operating the energy recovery system for the vehicle. In exemplary embodiments, the method may include the steps of: capturing energy from at least one of the shock absorber and braking mechanism of the vehicle using the spring system; storing the captured energy as potential energy in said spring system; and releasing the stored potential energy to provide a propulsion to the vehicle.

The present disclosure envisages an energy recovery system for a vehicle. The system comprises a spring system associated with at least one of a shock absorber and a braking mechanism of the vehicle. A linkage mechanism is provided between the spring system and the at least one of shock absorber and braking mechanism, wherein energy from the movement of the shock absorber or the application of the braking mechanism winds up the spring system, thereby storing potential energy. A control mechanism releases the stored potential energy in the spring system to provide propulsion to the vehicle.

In accordance with an embodiment of the present disclosure, the vehicle is a land-operating vehicle.

In accordance with an embodiment of the present disclosure, the land-operating vehicle is selected from the group consisting of an automobile, a truck, a bus, a recreational vehicle, and an all-terrain vehicle.

In accordance with an embodiment of the present disclosure the spring system is associated with other areas in the vehicle experiencing high torque and stress during operation.

In accordance with an embodiment of the present disclosure, the energy recovery further comprises a wind turbine mechanism associated with the spring system, the wind turbine mechanism captures wind energy when the vehicle is in motion and winds up the spring system.

In accordance with an embodiment of the present disclosure, the vehicle is a marine vehicle. In accordance with an embodiment of the present disclosure, the energy recovery system includes a water turbine mechanism associated with the spring system, the water turbine mechanism captures kinetic energy from moving water around the marine vehicle and winds up the spring system.

In accordance with an embodiment of the present disclosure, the control mechanism releases the stored potential energy in the spring system to power other onboard systems of the vehicle.

In accordance with an embodiment of the present disclosure, the vehicle is selected from the group consisting of a train and a tram.

In accordance with an embodiment of the present disclosure, the vehicle is a hybrid vehicle, wherein the hybrid vehicle utilizes both a spring system and a battery for energy storage and propulsion.

In accordance with an embodiment of the present disclosure, the spring system is a coil spring.

In accordance with an embodiment of the present disclosure, the spring system is a leaf spring.

The present disclosure also envisages a method of operating the energy recovery. The method includes: capturing energy from at least one of the shock absorber and braking mechanism of the vehicle using the spring system; storing the captured energy as potential energy in the spring system; and releasing the stored potential energy to provide propulsion to the vehicle.

In accordance with an embodiment of the present disclosure, the method further comprises capturing wind energy through a wind turbine mechanism when the vehicle is in motion and using it to wind up the spring system.

In accordance with an embodiment of the present disclosure, the method further comprises capturing kinetic energy from moving water around a marine vehicle through a water turbine mechanism and using it to wind up the spring system.

In accordance with an embodiment of the present disclosure, the stored potential energy is released to power other onboard systems of the vehicle.

In accordance with an embodiment of the present disclosure, the vehicle is a hybrid vehicle and utilizes both a spring system and a battery for energy storage and propulsion. Moreover, air compressor systems or hybrid/combination systems that employ spring modules and air compression systems as a means of storing potential energy that may be released at selectively predetermined intervals, or as desired by the user.

In accordance with an embodiment of the present disclosure, the method further comprises the spring system is a coil spring or a leaf spring.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a schematic diagram of an energy recovery system for vehicles, in accordance with an exemplary embodiment of the present disclosure.

FIG. 1A illustrates a block diagram of a method for using stored potential energy in a spring system to propel wheels of a vehicle, in accordance with an exemplary embodiment of the present disclosure.

FIG. 1B illustrates a block diagram of components used in a spring system that stores potential energy and releases that energy to propel wheels of a vehicle, in accordance with an exemplary embodiment of the present disclosure.

FIG. 2 illustrates a schematic view of the shock absorber, where the shock absorber is coupled to the linkage mechanism, in accordance with an exemplary embodiment of the present disclosure.

FIG. 3 illustrates a schematic view of the braking absorber mechanism, where the braking mechanism is coupled to the linkage mechanism, in accordance with an exemplary embodiment of the present disclosure.

FIG. 4 illustrates a schematic view of a moving support of the steering mechanism coupled to the linkage mechanism, in accordance with an exemplary embodiment of the present disclosure.

FIG. 5 illustrates a schematic front view of the wind turbine mechanism, where the wind turbine mechanism is coupled to the linkage mechanism, in accordance with an exemplary embodiment of the present disclosure.

FIG. 6 illustrates schematic side view of the wind turbine mechanism, where the wind turbine mechanism is coupled to the linkage mechanism, in accordance with an exemplary embodiment of the present disclosure.

FIG. 7 illustrates a schematic block diagram of the energy recovery system operable in marine vehicles, in accordance with an exemplary embodiment of the present disclosure.

FIG. 8 illustrates a block diagram of a method for recovering energy in a vehicle, in accordance with an embodiment of the present disclosure.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

To facilitate an in-depth understanding of the principles of the invention, it is essential to discuss the embodiments outlined in the figures while deploying specific language to elucidate the same. Nonetheless, this should not be construed as an attempt to limit the scope of the invention. Any modifications, further alterations in the depicted devices, described methods, and additional applications of the principles of the invention that ordinarily come to a person skilled in the art to which the invention pertains, are considered as part of this invention.

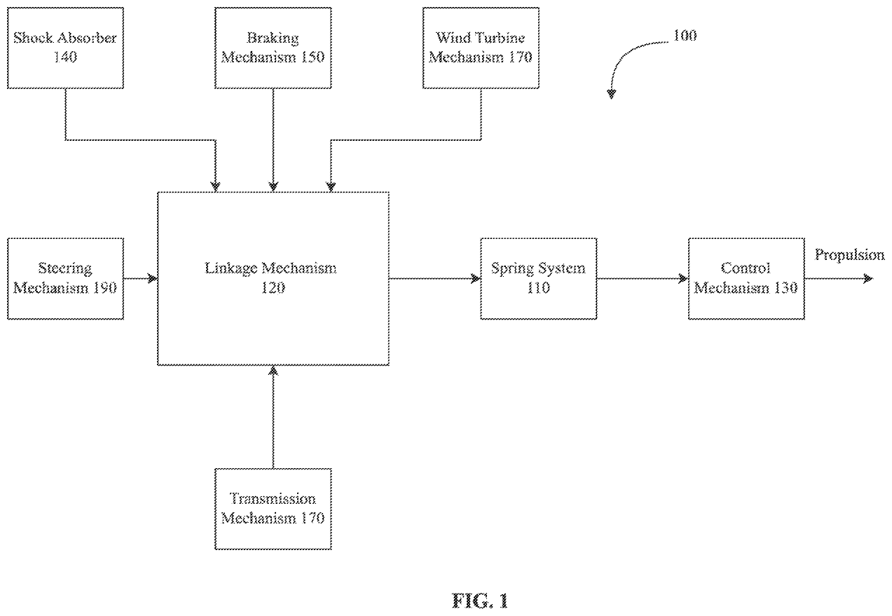

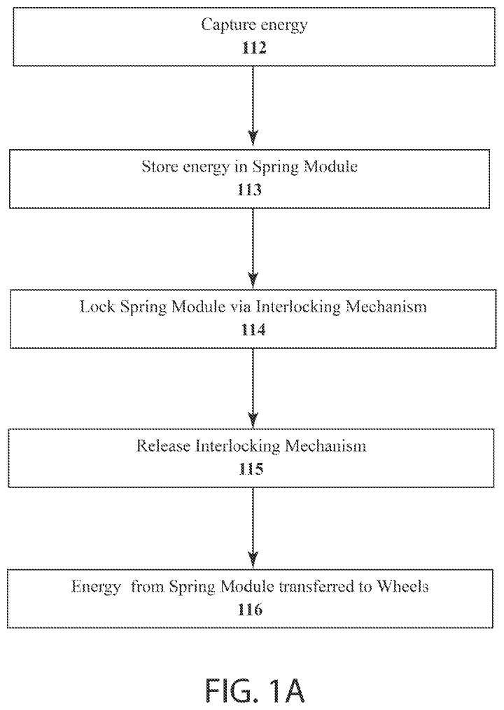

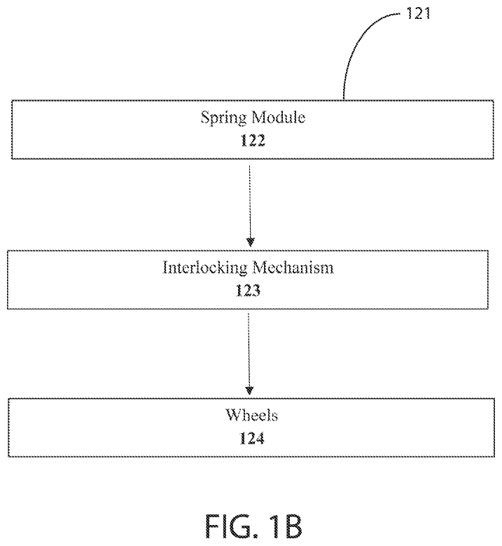

FIG. 1 illustrates a block diagram of an energy recovery system 100, in accordance with an exemplary embodiment of the present disclosure. The energy recovery system 100 (hereinafter interchangeably referred to as system 100) may be operable on terrestrial vehicles as well as marine vehicles. Different embodiments of the present invention may be implemented for operation on terrestrial vehicles and marine vehicles. The terrestrial vehicles or the land operating vehicles that the instant system 100 can be installed on include an automobile, a truck, a bus, a recreational vehicle, and an all-terrain vehicle. In exemplary embodiments, stored energy (for example stored in a spring or energy retention module), may be released by way of an interface that enables spinning the wheels of the vehicle—driven by the released energy.

In an embodiment of the present invention, system 100 comprises a spring system 110, associated with at least one of a shock absorber 140 and a braking mechanism 150 of the vehicle via a linkage mechanism 120. In a preferred embodiment of the present invention, the linkage mechanism 120 may be constituted of a series of mechanical arms, pivots, and gears. These components collaboratively facilitate the efficient transfer of kinetic energy from the movements of the shock absorber 140 or the application of the braking mechanism 150 to the spring system 110. Notably, any spring or series of springs may be employed without deviating from the scope of the present invention. In this disclosure, a spring may refer to any device consisting of an elastic but largely rigid material that may be bent or molded into a form (for example a coil) adapted to return into shape after being compressed or extended, so that the device can store energy when compressed and release energy when decompressed. The device may be made from a variety of elastic materials, including spring steel. In some embodiments, non-ferrous metals may be used, including phosphor bronze and titanium for parts requiring corrosion resistance, and low-resistance beryllium copper for springs carrying electric current.

Examples of spring devices that may be used for a spring system in accordance with the present invention, may include—without limitation: a tension/extension spring designed to operate with a tension load, so the spring stretches as the load is applied to it; a compression spring designed to operate with a compression load, so the spring gets shorter as the load is applied to it; a torsion spring adapted to receive an applied load by way of a torque or twisting force, rotating the spring through an angle as the load is applied; a flat spring; a machined spring; or any other type of spring that may be employed into system 100. Moreover, other devices (that may or may not incorporate springs) may be utilized, including, for example, an air compressor or the like. In some exemplary embodiments, an air compression system may be employed as a means of storing energy.

The shock absorbers 140 and braking mechanisms 150 are essential to the vehicle's operation and generate kinetic energy during use of the vehicle. More specifically, this kinetic energy is generated by the movements of the shock absorbers 140, associated with the act of shock absorption. In simpler terms, the kinetic energy generated by the shock absorbers 140 results from the oscillatory vertical displacement thereof experienced during the traversal of the vehicle along irregular terrains.

In one embodiment the Shock Absorber 140 or Braking Mechanism 150 that is coupled to Linkage Mechanism 120, absorbs and stores potential energy into Spring System 110 that is released as kinetic energy that propels either the front two wheels of a terrestrial vehicle or the rear two wheels of a terrestrial vehicle. In another embodiment, where the terrestrial vehicle operates by rear wheel drive, the Spring System 110 releases stored potential energy into the front wheels. In an alternative embodiment, where the terrestrial vehicle operates by front wheel drive, the Spring System 110 releases stored potential energy into the rear wheels.

FIG. 1A illustrates a block diagram of a method 111 for storing potential energy that is then released as kinetic energy for the propulsion of wheels in a terrestrial vehicle, in accordance with an embodiment of the present disclosure. In accordance with an embodiment, the method 111 of storing potential energy in a spring and releasing it as kinetic energy into wheels, involves: at block 112, capturing energy from a shock absorber or braking mechanism of a vehicle; at block 113, storing the captured energy as potential energy in a Spring Module; at block 114, locking the Spring Module from unwinding, depressing or decharging, by means of an interlocking mechanism that maintains the captured potential energy; at block 115, releasing the interlocking mechanism, which allows the spring to unwind, depress or unwind, creating an output of kinetic energy; and at block 116, transferring that kinetic energy to the wheels of the vehicle which propels the wheels forward thereby moving the vehicle.

FIG. 1B illustrates a block diagram of a wheel propelling spring system 121, in accordance with an exemplary embodiment of the present disclosure. With reference to the method outlined in FIG. 1A, a Spring Module 122 component can be charged by an external force, thereby winding, compressing or charging the Spring Module 122, such that it stores potential energy. An Interlocking Mechanism 123 can be then used to lock the Spring Module 122, into place, maintaining the potential energy that it has stored. The Interlocking Mechanism 123 may release the Spring Module 122, thereby creating kinetic energy through the decompression, uncoiling or unwinding of the spring. Such kinetic energy can then be routed to Wheels 124, which then begin to turn in response to the kinetic energy from the Spring Module 122. The turning Wheels 124 may then propel the vehicle forward.

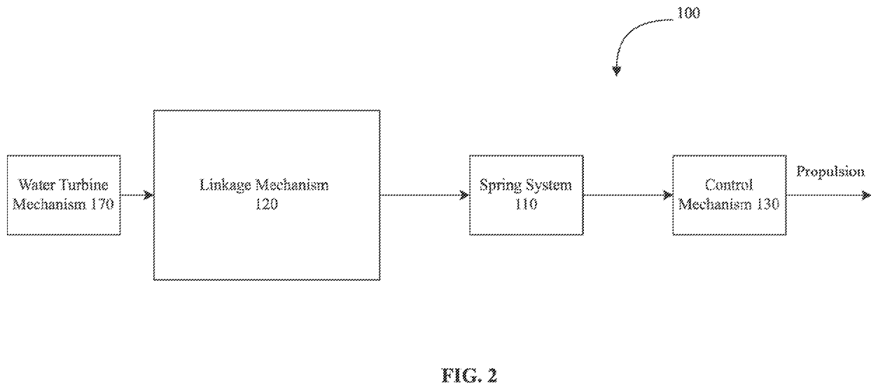

FIG. 2 illustrates a schematic view of the shock absorber 140, where the shock absorber is coupled to the linkage mechanism 120, in accordance with an exemplary embodiment of the present disclosure.

Similar to the shock absorbers 140, the braking mechanism 150 also generates kinetic energy during the course of operation of the vehicle. More specifically, the braking mechanism 150 in a vehicle, when engaged, initiates a deceleration process that effectively transforms the vehicle's kinetic energy, derived from its motion, into a different form of energy. In the present invention, this generated kinetic energy, instead of being dissipated as heat due to friction, is harnessed and utilized to charge or wind up the spring system 110. This process of energy transformation and storage allows for the efficient use of kinetic energy that would otherwise be wasted, thereby contributing to the overall energy efficiency of the vehicle. In exemplary embodiments, stored energy (for example stored in a spring or energy retention module), may be released by way of an interface that enables spinning the wheels of the vehicle—driven by the released energy.

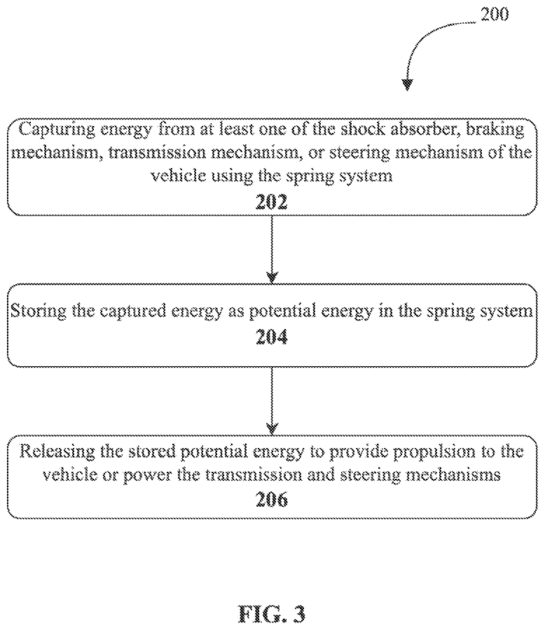

FIG. 3 illustrates a schematic view of the braking absorber mechanism 150, where the braking mechanism 150 is coupled to the linkage mechanism 120, in accordance with an exemplary embodiment of the present disclosure. As seen in FIG. 3, a movable support 150A is supported on a vehicle V. The movable support 150A is operable to be displaceable along a track, where such track may be part of a chassis of the vehicle V. More specifically, the movable support 150A captures the kinetic energy resulting from sudden acceleration or deceleration of the vehicle V, which is then transferred to the spring system 110 through the linkage mechanism 120.

Referring back to FIG. 1, the system further comprises a control mechanism 130 operative to regulate the discharge of stored potential energy from the spring system 110. Upon activation of the control mechanism 130, the spring system 110 is actuated to release its accumulated potential energy. This released energy can be channeled to facilitate movement of the vehicle. In doing so, the mechanism augments the vehicle's propulsion, enhancing its energy efficiency.

In one embodiment, the control mechanism 130 may comprise a manual switch or button accessible to the vehicle operator, allowing for selective actuation of the spring system. In another embodiment, the control mechanism 130 might incorporate automated sensors that detect specific conditions, such as vehicle speed or terrain, and autonomously decide when to release the stored energy for optimal efficiency. In yet another embodiment, the control mechanism 130 could be integrated with the vehicle's central processing unit, ensuring synchronized operation with other vehicular systems for seamless energy redistribution and utilization.

Furthermore, the control mechanism 130 might feature adjustable settings, permitting the user to predetermine the conditions or thresholds under which the spring system 110 releases its stored energy. In addition, safety measures may be integrated into the control mechanism 130, ensuring that the release of potential energy is controlled and gradual, preventing any sudden jolts or movements that might compromise the stability of the vehicle.

In another embodiment, the control mechanism 130 can also release the stored potential energy in the spring system 110 to power other onboard systems of the vehicle, thereby further enhancing the vehicle's energy efficiency.

The spring system 110 is further adaptable to connect with various regions of the vehicle that undergo pronounced torque or experience substantial stress during vehicular movements. By strategically placing or integrating the spring system 110 in these regions, it is positioned to capture and store additional kinetic energy that would otherwise be dissipated.

In one embodiment, the spring system 110 might be coupled with the vehicle's drivetrain components, allowing for the capture of energy during acceleration and deceleration phases. In another embodiment, the spring system 110 can be associated with the vehicle's chassis or suspension components, especially those that endure recurrent flexing or bending motions, thereby harnessing more energy from the vehicle's routine operational dynamics.

Furthermore, specific vehicular parts that encounter repetitive movements, such as steering mechanism or certain articulating joints, might also be integrated with the spring system to capitalize on their motion-related energy. Through these various associations, the spring system 110 not only enhances energy storage capabilities but also contributes to refining the vehicle's stability and ride comfort by providing a dampening effect against abrupt forces or jolts.

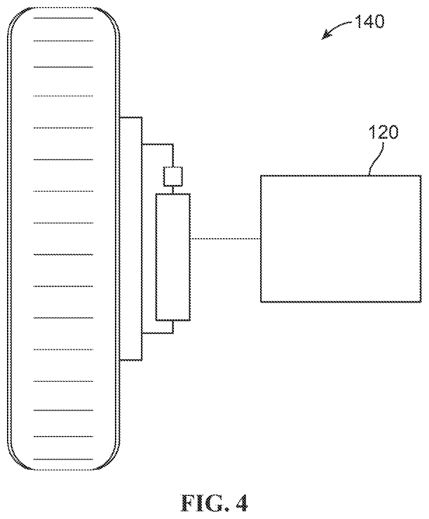

FIG. 4 illustrates a schematic view of a moving support of the steering mechanism 190 coupled to the linkage mechanism 120, in accordance with an exemplary embodiment of the present disclosure. Just like moving support 150A that was positioned along the length of the vehicle V, the system 100 can include a moving support 190A that is positioned along a width of the vehicle V. The moving support 190A is operable to be displaced when the steering mechanism 190 is used by the driver of the vehicle for capturing the kinetic energy thereof. The captured kinetic energy can be transferred to the spring system 110 using the linkage mechanism 120.

The spring system 110 encompasses a variety of spring configurations suitable for energy capture and storage. Within the scope of the disclosed system, several spring types can be considered. In one embodiment, coil springs, known for their helical structure and capability to handle both tension and compression, are utilized. Such springs can be advantageous due to their compact design and linear load-deflection characteristics, making them suitable for vehicles with space constraints or those requiring consistent energy release.

In another embodiment, leaf springs are employed. Comprising multiple layers of flat, elongated strips of material, leaf springs are particularly adept at distributing loads along their length. Given their widespread use in larger vehicles, such as trucks, they can be ideal for applications where the vehicle encounters variable loads or rough terrains, ensuring efficient energy capture during such conditions. Beyond the aforementioned types, torsion springs, which store energy in a twisting or rotational motion, or gas springs, utilizing compressed gas, can also be incorporated within the system based on specific needs or vehicle characteristics.

The selection of the spring type is pivotal and can be tailored to various parameters, such as the vehicle's structural design, its primary operational environment, and the desired efficiency in energy recuperation. By ensuring a harmonized integration of the spring system with the vehicle's inherent mechanics, optimal energy recovery and subsequent propulsion assistance can be achieved.

In an alternative embodiment, the energy recovery system 100 includes provisions for harnessing wind energy during the vehicle's movement. One such provision involves integrating a wind turbine mechanism 170 with the spring system 110.

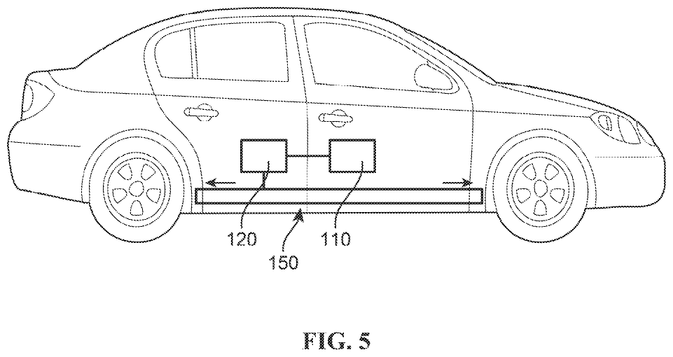

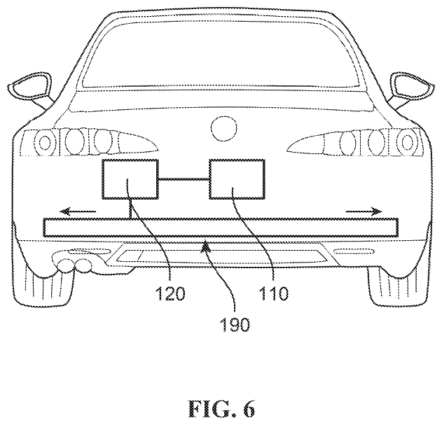

FIG. 5 illustrates a schematic front view of the wind turbine mechanism 170, where the wind turbine mechanism 170 is coupled to the linkage mechanism 120, in accordance with an exemplary embodiment of the present disclosure. FIG. 6 illustrates schematic side view of the wind turbine mechanism 170, where the wind turbine mechanism 170 is coupled to the linkage mechanism 120, in accordance with an exemplary embodiment of the present disclosure.

As seen in FIG. 5 and FIG. 6, air enters an air intake channel 170A to interact with wind turbines present in the wind turbine mechanism 170. In a particular embodiment, the wind turbine mechanism 170 features a set of blades or rotors that rotate upon interaction with oncoming wind. As the vehicle traverses, the relative motion against the ambient air induces a flow, causing the blades of the wind turbine to spin.

Subsequent to blade rotation, the wind turbine mechanism 170, through a series of gears or direct drive systems, can transfer the rotational energy to the spring system 110 using the linkage mechanism 120. The wind turbine mechanism 170 is thus designed to wind or tension the springs using the captured wind energy, storing it as potential energy within the springs.

The placement of the wind turbine mechanism 170 can vary depending on the vehicle's design and aerodynamics. For instance, it can be positioned at frontal areas to capitalize on headwinds, or strategically located at other aerodynamic points to maximize energy capture. In exemplary embodiments, the “fans” can be placed “back to back” so that the same wind force can go through one fan and into another in a manner so as to conserve as much wind energy as possible.

In addition, the wind turbine mechanism 170 may incorporate adjustable blade designs, allowing for optimization based on varying wind speeds and vehicle velocities. This ensures efficient energy capture across a spectrum of driving conditions.

Through the integration of the wind turbine mechanism 170, the energy recovery system 100 not only recovers kinetic energy from the vehicle's motions but also augments energy storage by harnessing environmental wind energy. This multipronged approach further accentuates the vehicle's overall energy efficiency and sustainability.

Moreover, air compressor systems or hybrid/combination systems that employ spring modules and air compression systems as a means of storing potential energy that may be released at selectively predetermined intervals, or as desired by the user.

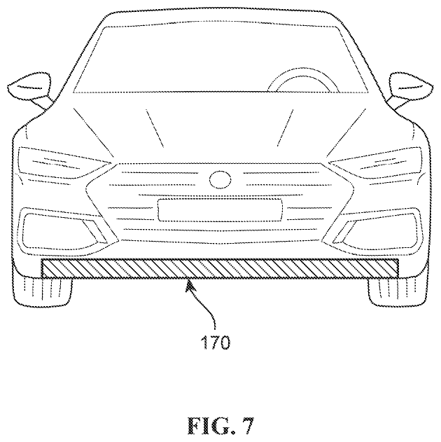

The present disclosure further envisages the implementation of the system 100 in marine vehicles. FIG. 7 illustrates a schematic block diagram of the energy recovery system 100 operable in marine vehicles, in accordance with an exemplary embodiment of the present disclosure. In embodiments designed for marine vehicles, the system 100 includes a water turbine mechanism 180 operatively coupled to the spring system 110. The water turbine mechanism 180 is designed to capture kinetic energy from the surrounding water as the marine vehicle moves through it.

The water turbine mechanism 180 functions by utilizing turbine blades which, when engaged by the moving water, induce a rotational movement. This rotational movement is then used to wind up the spring system 110, storing potential energy for later use.

The location of the water turbine on the marine vehicle can vary depending on design considerations. Possible locations for the water turbine mechanism 180 include the side surfaces of the marine vehicle, underneath the marine vehicle, or at its rear. Each location provides different advantages based on the specific design and operational conditions of the marine vehicle.

By including the water turbine mechanism 180, the energy efficiency of marine vehicles can be improved, making better use of the kinetic energy present in their operating environment.

This energy recovery system can be applied to a wide range of vehicles, including but not limited to automobiles, trucks, buses, recreational vehicles, all-terrain vehicles, trains, trams, and hybrid vehicles. In the case of hybrid vehicles, the energy recovery system can work in conjunction with a battery system for energy storage and propulsion.

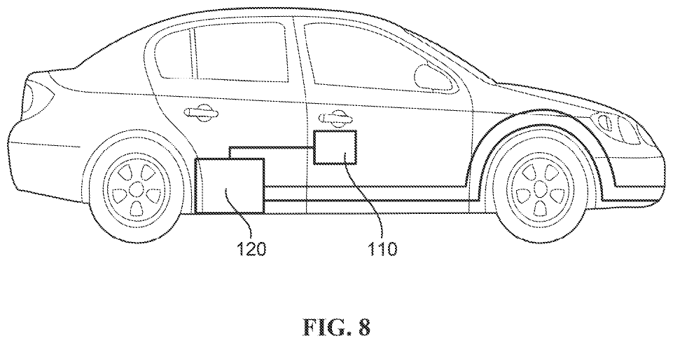

FIG. 8 illustrates a block diagram of a method for recovering energy in a vehicle, in accordance with an embodiment of the present disclosure. In accordance with an embodiment, the method 200 of operating the energy recovery system 100, involves: at block 202, capturing energy from the shock absorber and braking mechanism of the vehicle using the spring system; at block 204, storing the captured energy as potential energy in the spring system; and at block 206, releasing the stored potential energy to provide propulsion to the vehicle or power other onboard systems.

The method can also involve capturing wind energy or water energy to wind up the spring system, thereby providing additional sources of energy for the vehicle.

Furthermore, the energy recovery system could be implemented in other transport systems such as trains or trams (not shown in the figures). In such an embodiment, the shock absorbers in the wheels or the braking system could be utilized to harness energy during operation.

It should be understood that the embodiments described above are illustrative examples and should not be seen as limiting the scope of the invention. The system can be adapted to various vehicles and energy-harvesting conditions without deviating from the scope of the invention.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions.

Although specific terms may be employed herein, they are used only in generic and descriptive sense and not for purposes of limitation. Accordingly, the present invention is not limited to the specific embodiments illustrated herein.

What is claimed is:

1. An energy recovery system for a vehicle, the energy recovery system comprising:
a spring system associated with at least one of a shock absorber and a braking mechanism of the vehicle;
a linkage mechanism between said spring system and said at least one of shock absorber and braking mechanism, wherein energy from a movement of said shock absorber or an application of said braking mechanism winds up said spring system, thereby storing potential energy; and
a control mechanism that releases the stored potential energy in said spring system to provide propulsion to the vehicle.

2. The energy recovery system of claim 1, wherein said vehicle is a land-operating vehicle.

3. The energy recovery system of claim 2, wherein said land-operating vehicle is selected from the group consisting of an automobile, a truck, a bus, a recreational vehicle, and an all-terrain vehicle.

4. The energy recovery system of claim 1, wherein said spring system is associated with other areas in the vehicle experiencing high torque and stress during operation.

5. The energy recovery system of claim 1, further comprising: a wind turbine mechanism associated with said spring system, said wind turbine mechanism captures wind energy when the vehicle is in motion and winds up said spring system.

6. The energy recovery system of claim 1, wherein said control mechanism releases the stored potential energy in said spring system to power other onboard systems of the vehicle.

7. The energy recovery system of claim 1, wherein the energy released by the control mechanism provides propulsion to wheels that move the vehicle.

8. The energy recovery system of claim 7, wherein the vehicle is rear wheel drive and the wheels that are propelled by the spring system are the front wheels.

9. The energy recovery system of claim 7, wherein the vehicle is front wheel drive and the wheels that are propelled the spring system are the rear wheels.

10. The energy recovery system of claim 1, wherein said vehicle is selected from the group consisting of a train and a tram.

11. The energy recovery system of claim 1, wherein the vehicle is a hybrid vehicle.

12. The energy recovery system of claim 10, wherein the hybrid vehicle utilizes both a spring system and a battery for energy storage and propulsion.

13. The energy recovery system of claim 1, wherein the spring system is a coil spring.

14. The energy recovery system of claim 1, wherein the spring system is a leaf spring.

15. A method of operating the energy recovery system of claim 1, the method comprising:
capturing energy from at least one of the shock absorber and braking mechanism of the vehicle using the spring system;
storing the captured energy as potential energy in said spring system; and releasing the stored potential energy to provide a propulsion to the vehicle.

16. The method of claim 15, further comprising capturing wind energy through a wind turbine mechanism when the vehicle is in motion and using it to wind up the spring system.

17. The method of claim 15, wherein the stored potential energy is released to power other onboard systems of the vehicle.

18. The method of claim 15, wherein the vehicle is a hybrid vehicle and utilizes both a spring system and a battery for energy storage and propulsion.

19. The method of claim 15, wherein the spring system is a coil spring.

20. The method of claim 15, wherein the spring system is a leaf spring.
